(19) United States
(12) Patent Application Publication
(10) Pub. No.: US 2016/0169413 A1
(43) Pub. Date: Jun. 16, 2016

(54) Counterweight System and Method

(71) Applicant: Caterpillar Inc., Peoria, IL (US)

(72) Inventors: Timothy E. Camacho, Morton, IL (US); Kent D. Smith, Mapleton, IL (US); Christopher M. Brian, Peoria, IL (US); Scott A. Favreau, East Peoria, IL (US); Bryce A. Quartier, Peoria, IL (US)

(73) Assignee: CATERPILLAR INC., Peoria, IL (US)

(21) Appl. No.: 14/571,913

(22) Filed: Dec. 16, 2014

(51) Int. Cl. F16L 1/036; B66C 23/90; B66C 23/36; B66C 13/18; B66C 23/76

(52) U.S. Cl. CPC F16L 1/036; B66C 13/18; B66C 23/76; B66C 23/36; B66C 23/90

(57) ABSTRACT

A pipelayer includes an undercarriage, a boom movable relative to the undercarriage in a first lateral direction, and a counterweight movable relative to the undercarriage in a second lateral direction opposite the first lateral direction and ranging between a deployed position and a retracted position. A counterweight position sensor is configured to determine a current position of the counterweight and generate a counterweight position signal, and an operator interface is operably coupled to the counterweight position sensor and configured to display counterweight position information based on the counterweight position signal.

### TECHNICAL FIELD

The present disclosure generally relates to constructions vehicles and machines, and more particularly relates to pipelayers.

### BACKGROUND

Pipelayers are specialized vehicles used for installing large, heavy lengths of conduit into or above ground. Such conduits may be used, for example, to carry oil and gas from remote well locations over vast distances to a receiving station or refinery. In so doing, transportation costs for shipping, trucking or otherwise moving the oil and gas can be avoided. In addition to petroleum pipelines, pipelayers can also be used to install piping for other materials, or for installing of drain tile, culverts or other irrigation and drainage structure.

However, the installation of such pipelines is often very challenging. The locations of such oil and gas wells are commonly some of the most remote areas on earth, and the terrain over which the pipeline must traverse is often some of the most rugged. The climate of the installations can have very high or very low temperatures. The land may have significant elevational changes, and be subject to mudslides, severe weather, deep forestation and the like. In order to install the pipe, the pipelayer must be able to operate in all of the above-climate conditions, navigate over such terrain, and still be able to lift loads often in excess of 200,000 pounds.

Not only must pipelayers be able to handle such tasks, but given that the pipes are installed in long segments welded or otherwise secured together, they must be installed with great precision. The ends of the pipe being welded together must butt up against each other within a very tight tolerance. In addition, the pipes are often installed in connected fashion. This can result in a very long length of conduit (sometimes exceeding a mile) which must be laid into the ground in coordinated fashion. A series of pipelayers in such a situation will therefore be called upon to work in concert to lay the pipe.

When installing pipelines, if a natural or pre-made easement does not exist, a path through the terrain is first cleared through the forest, mountain pass or other geographical challenge at hand. A trench is then dug to the desired size, which is typically many feet deep and many feet wide. A right-of-way is also provided to one or both sides of the trench to allow for passage of trucks to transport the pipe into the location, and for passage of pipelayers to install the pipe. This right-of-way is ideally flat and sufficiently wide to easily accommodate the pipelayer but given the constraints imposed by the area topography and space availabilities of the local region or country, this may not always be the case. Pipelayers therefore often need to carry not only very heavy loads, but do so without being on level, stable ground.

Current pipelayers typically work on a track-type undercarriage and operate with a side-boom that can be extended at a variable angle to the chassis of the pipelayer. A cable is trained from a winch or other power source through a series of pulleys and terminates in a grapple hook or other suitable terminus. The grapple hook or other suitable terminus can then be secured to the pipe in such a way that when the winch recoils, the pipe is lifted. The boom arm is then extended and the pipelayer itself is navigated to a desired location for accurate installation of the pipe.

While effective, it can be seen that the weight of the pipe is positioned in cantilevered fashion away from the chassis, engine and undercarriage of the pipelayer. As the chassis, engine and undercarriage comprise the majority of the weight of a pipelayer, depending on the weight of the pipe being lifted and the length of the boom arm, the pipelayer can be subject to potential tipping and instability, as is generally known. Conversely, if the pipelayer is to be maintained in a stable position, the ability of the pipelayer to access the desired installation location can be significantly limited.

To offset these concerns, current pipelayers typically include a counterweight on the side of the pipelayer opposite to the boom. The counterweight may comprise a series of heavy plates secured to a hinged structure such that through the use of a hydraulic cylinder or the like, the counterweight can be moved relative to the chassis of the pipelayer and thus counterbalance the weight of the load being lifted.

However, the counterweight systems of currently available pipelayers are operated entirely at the discretion of the operator, who can move the counterweight as he or she sees fit. In some instances, however, the operator does not actively adjust the counterweight during operation of the pipelayer, and an operator's adjustments of the counterweight may not optimize lifting capacity or stability of the pipelayer.

### SUMMARY OF THE DISCLOSURE

In accordance with one aspect of the disclosure, a pipelayer is provided that includes an undercarriage, a boom movable relative to the undercarriage in a first lateral direction, and a counterweight movable relative to the undercarriage in a second lateral direction opposite the first lateral direction and ranging between a deployed position and a retracted position. A counterweight position sensor is configured to determine a current position of the counterweight and generate a counterweight position signal, and an operator interface is operably coupled to the counterweight position sensor and configured to display counterweight position information based on the counterweight position signal.

In another aspect of the disclosure that may be combined with any of these aspects, a method of operating a pipelayer includes detecting a position of a counterweight relative to an undercarriage using a counterweight position sensor and generating a counterweight position signal, communicating the counterweight position signal to an operator interface, and displaying, on the operator interface, counterweight position information based on the counterweight position signal.

In another aspect of the disclosure that may be combined with any of these aspects, a counterweight system is provided for a pipelayer having an undercarriage, the counterweight system including a counterweight movable laterally relative to a first side of the undercarriage between a deployed position and a retracted position, and a counterweight position sensor configured to determine a current position of the counterweight and generate a counterweight position signal. A processor is coupled to the counterweight position sensor and configured to generate counterweight position information based on the counterweight position signal, and an operator interface is coupled to the processor and configured to display the counterweight position information.

In another aspect of the disclosure that may be combined with any of these aspects, the counterweight position signal is indicative of a counterweight moment, and the counterweight position information displayed by the operator interface comprises a current load capacity of the pipelayer based on the counterweight moment.

In another aspect of the disclosure that may be combined with any of these aspects, a boom sensor is configured to determine a boom load and generate a boom load signal, and the operator interface is also coupled to the boom sensor and further configured to display boom load information based on the boom load signal.

In another aspect of the disclosure that may be combined with any of these aspects, a processor is coupled to the boom sensor, the counterweight sensor, and the operator interface, the processor being programmed to determine the counterweight position information based on the counterweight position signal and communicate the counterweight position information to the operator interface.

In another aspect of the disclosure that may be combined with any of these aspects, the counterweight has a counterweight mass, the boom load signal is indicative of a boom moment, and the processor is further programmed to determine a counterweight moment based on the counterweight position signal and the counterweight mass.

In another aspect of the disclosure that may be combined with any of these aspects, the processor is further programmed to determine a current load capacity of the pipelayer based on the counterweight moment, the counterweight position information displayed by the operator interface comprises the current load capacity of the pipelayer, and the boom load information displayed by the operator interface comprises an actual load value.

In another aspect of the disclosure that may be combined with any of these aspects, the current load capacity and the actual load value are expressed as a capacity usage value based on a ratio of the boom moment to the counterweight moment.

In another aspect of the disclosure that may be combined with any of these aspects, a counterweight actuator is operably coupled to the counterweight and the processor, wherein the processor is further programmed to automatically command operation of the counterweight actuator based on the capacity usage value.

In another aspect of the disclosure that may be combined with any of these aspects, the processor is further programmed to generate a counterweight move signal based on a comparison of the counterweight moment and the boom moment, and the counterweight position information displayed by the operator interface comprises the counterweight move signal.

### BRIEF DESCRIPTION OF THE DRAWINGS

FIG. 1 is an isometric view of pipelayer constructed in accordance with the teachings of this disclosure.

FIG. 2 is a front view of a pipelayer relative to a trench in which pipe is being laid, with a boom of the pipelayer extended to a distance providing the pipelayer with maximum lifting capacity.

FIG. 3 is a front view of the pipelayer similar to FIG. 2, but showing the pipelayer boom extended to a normal operating distance and a counterweight of the pipelayer in a closed position.

FIG. 4 is a front view of the pipelayer similar to FIG. 3, but showing the counterweight deployed to counterbalance the load being lifted.

FIG. 5 is an enlarged front view of a counterweight system of the pipelayer of FIG. 4.

FIG. 6 is a schematic representation of the pipelayer including the counterweight control system, according to the present disclosure.

### DETAILED DESCRIPTION

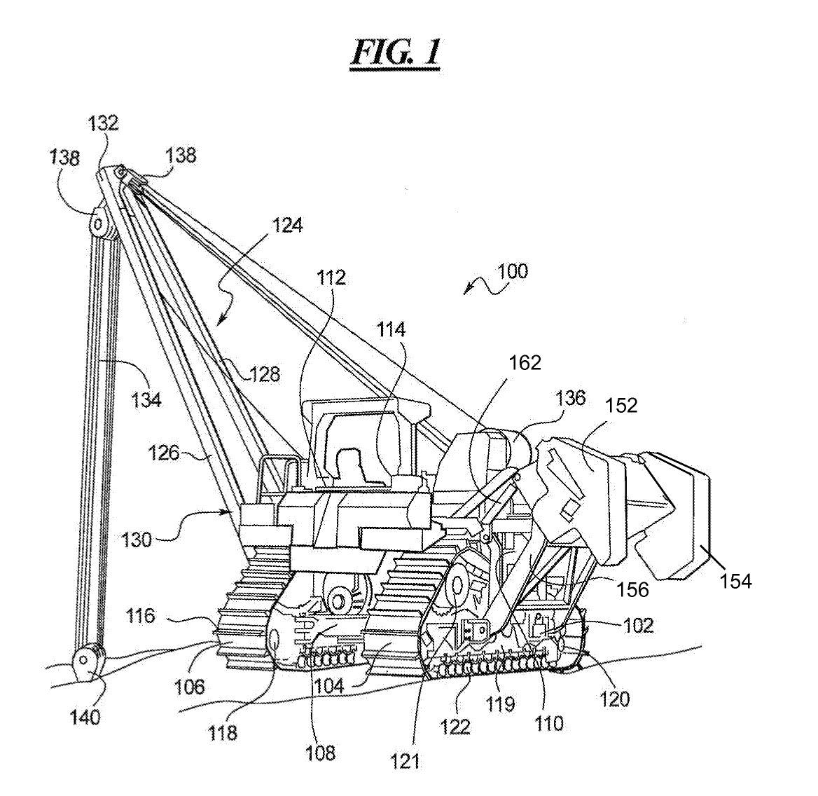

Referring now to the drawings, and with specific reference to FIG. 1, a pipelayer constructed in accordance with the present disclosure is generally referred to by reference numeral 100. While the following detailed description and drawings are made with reference to a pipelayer, it is important to note that the teachings of this disclosure can be employed on other earth moving or construction machines including, but not limited to, loaders, back-hoes, lift-trucks, cherry-pickers, forklifts, excavators, or any other movable vehicle where a load is being lifted at a distance from the main body of the vehicle.

The pipelayer 100 may include an undercarriage 102 comprised of first and second drive tracks 104, 106 supporting a chassis 108. A power source, typically a diesel engine 110, is supported by the chassis 108. An operator seat 112 and control console 114 may also be supported by the chassis 108 from which the operator can control one or both of the first and second drive tracks 104 and 106 to drive the pipelayer 100 forward, backward and turn. Each of the first and second drive tracks 104, 106 may be composed of a series of interlinked track shoes 116 in an oval track or high drive configuration. As shown, the tracks 104, 106 may be trained around first and second idlers 118, 120 supported by a track roller frame 119, a sprocket 121, as well as a series of other rollers 122 in a high-drive configuration.

Extending relative to the undercarriage 102 is a boom 124. The boom 124 may include first and second legs 126, 128 independently hinged to the undercarriage 102 at a base 130, and which terminate at a boom tip 132. The boom 124 may be up any length desired, with up to twenty-eight or more feet long being suitable. A lifting cable 134 extends from a winch 136 through a series of sheaves 138 at the boom tip 132 and terminates in a grapple hook 140, vacuum lift (not shown), or other suitable arrangement for wrapping around or otherwise securing to a pipe 142 (FIG. 3) to be lifted.

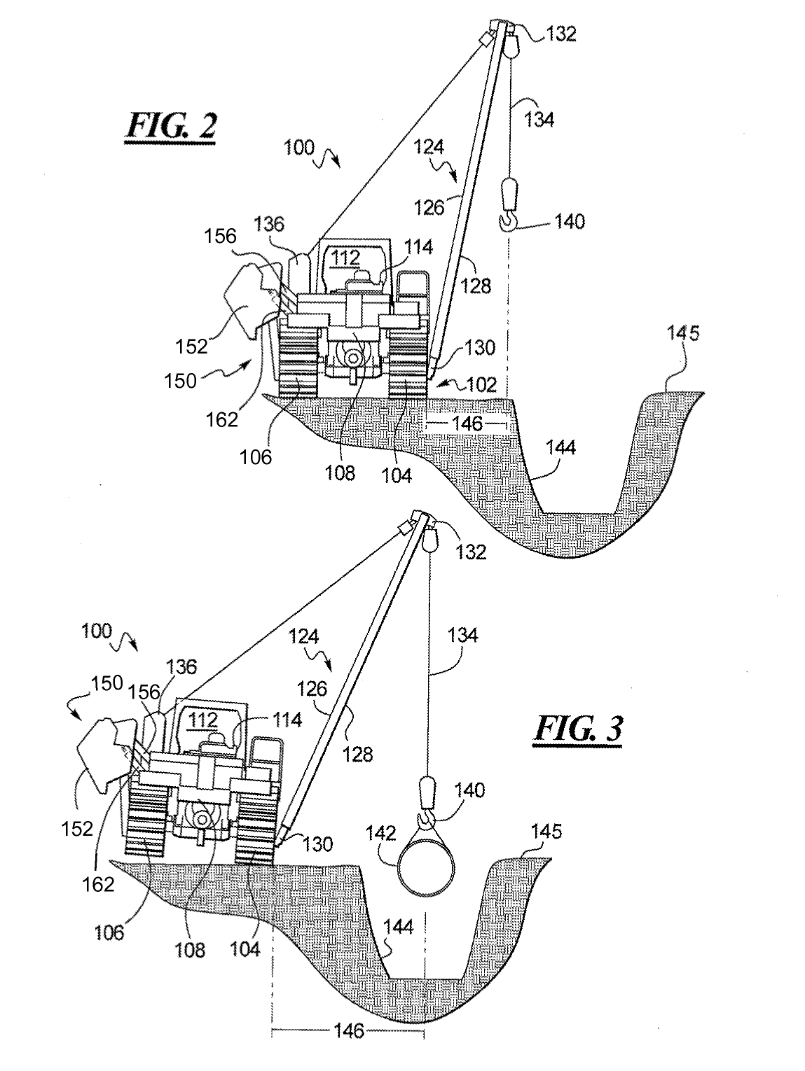

In operation, FIGS. 2 and 3 show that the pipelayer 100 is typically navigated by tracks 104, 106 to be adjacent a trench 144 pre-dug into ground 145. More precisely, the pipelayer 100 should be positioned away from the trench 144 according to applicable regulations. Once in such a position, the boom 124 may be extended away from the undercarriage 102 to facilitate lifting the pipe 142 and laying same into the trench 144. For the purposes of this disclosure, the lateral distance that the boom 124 is extended away from the undercarriage 102 is referred to as boom overhang 146. More specifically, the boom overhang 146 may be the lateral distance from the outside edge of the second drive track 106, located on the boom side of the pipelayer 100, to the boom tip 132.

The pipelayer 100 may have its greatest lifting capacity when the boom 124 is extended away from the undercarriage 102, in a first lateral direction, by a boom overhang 146 of zero to four feet, as shown in FIG. 2. This distance gives the pipelayer 100 its shortest tipping point. Current pipelayers are provided with myriad different lifting capacities, with 40,000; 90,000; 160,000; and 214,000 pound lifting capacities being examples. However, with the direction of the industry gaining momentum to put larger, heavier pipe in the ground, machines with even larger lifting capacities are desired. Regardless of the maximum lifting capacity of the given pipelayer, it is to be understood that the entire pipelayer 100, including the undercarriage 102, boom 124, and diesel engine 110, as dictated by current ISO (International Organization for Standardization) standards needs to be designed and engineered to handle the specified capacity load. This is true even though that maximum lifting capacity is not often called for, the importance of which will be discussed in further detail herein.

Referring now to FIG. 3, it will be seen that the boom 124 has been extended so that the boom overhang 146 is much greater than that shown in FIG. 2. In fact, in such a position the weight of the pipe 142, length of the boom 124 and the boom overhang 146 may create a boom moment great enough to overcome the weight of the undercarriage 102, diesel engine 110 and associated machinery, and thereby start to cause the pipelayer 100 to tilt. As a result of this and other factors, when the boom 124 is positioned as shown in FIG. 3, the lifting capacity and stability of the pipelayer 100 may be significantly diminished. Despite the reduced lifting capacity, operation of the boom 124 in an extended position may be necessary due to the diameter of the pipe 142, the relative dimensions of the trench 144 and pipelayer 100, or other factors. In other words, as the pipe 142 may itself have a diameter of, for example, three or four feet, and the pipelayer 100 may be required to be a minimum of the depth of the trench 144 away from the trench 144, the boom overhang 146 during normal operation may be well past the point of maximum lifting capacity.

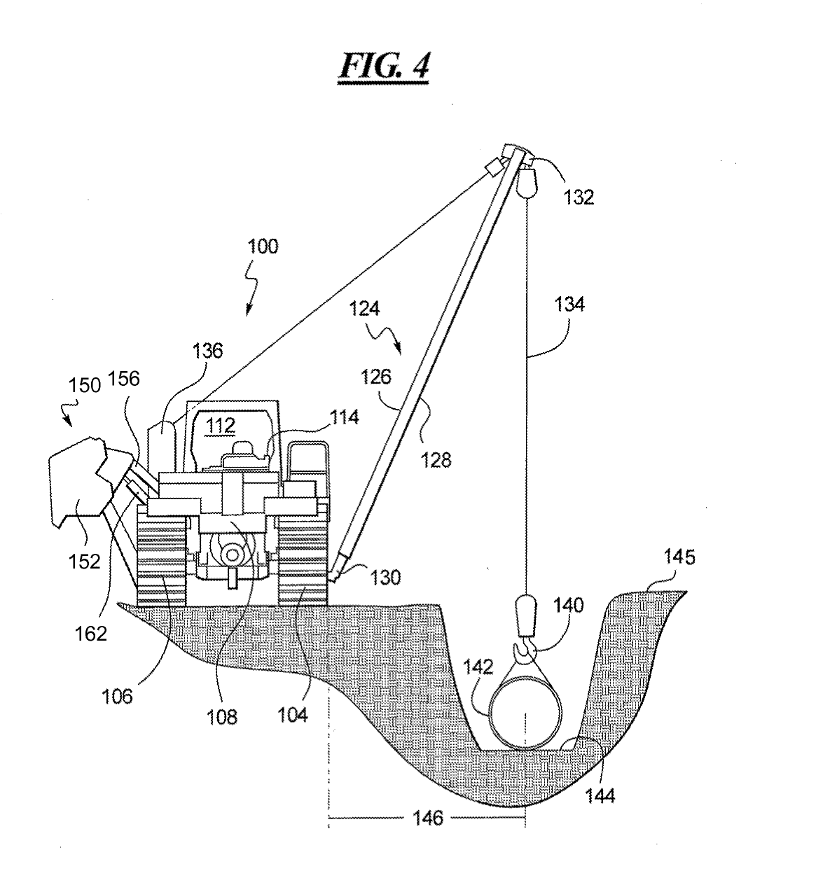

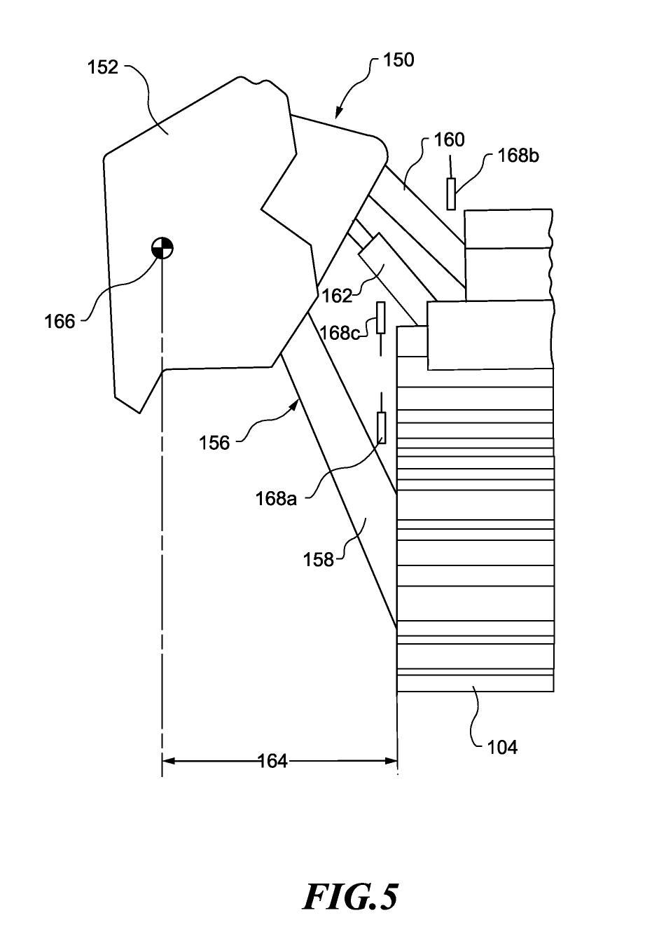

A counterweight system 150 may be provided for offsetting the moment created by the load when the boom 124 is extended to the position shown in FIG. 3, thereby to stabilize and/or increase the load capacity of the pipelayer 100. As best shown in FIGS. 4 and 5, the counterweight system 150 may include a counterweight 152 supported for movement in a second lateral direction opposite the first lateral direction, away from the boom 124. More specifically, the counterweight 152 may be movable between a retracted position where the counterweight 152 is adjacent the chassis 108, as best shown in FIGS. 2 and 3, and a deployed position in which the counterweight 152 is spaced from the chassis 108, as best shown in FIGS. 4 and 5.

In the illustrated embodiment, the counterweight 152 includes a series of heavy plates 154 (see FIG. 1) secured to a counterweight frame 156. The counterweight frame 156 may include a pair of lower arms 158 hingedly attached to the undercarriage 102 and a pair of upper arms 160 hingedly attached to the chassis 108. The counterweight frame 156, therefore, may pivot to permit movement of the counterweight 152 between the retracted and deployed positions, or any point therebetween. The counterweight system 150 may further include a counterweight actuator, such as a counterweight hydraulic cylinder 162, coupled to the chassis 108 and the counterweight frame 156 and configured to move the counterweight frame 156 and attached counterweight 152.

The counterweight 152 has a varying counterweight moment that depends on the position of the counterweight 152. The position of the counterweight 152 defines a counterweight overhang 164 by which the counterweight 152 is laterally offset from the undercarriage 102. More specifically, the counterweight overhang 164 may be the lateral distance from the outside edge of the first drive track 104, located on the counterweight side of the pipelayer 100, to a center of gravity 166 of the counterweight 152. Accordingly, by moving the counterweight 152 from the retracted position to the deployed position, the counterweight moment will increase, thereby shifting the center of gravity of the pipelayer 100 laterally away from the trench 144 and balancing the pipelayer 100.

The counterweight system 150 may further include a counterweight position sensor 168 configured to measure a parameter indicative of the counterweight overhang 164. The counterweight position sensor 168 may be provided in a number of forms including, but not limited to, an encoder provided on a shaft of the counterweight actuator, a rotary sensor, a magnetic sensor, a proximity switch, or the like. Furthermore, the counterweight position sensor 168 may be located in one of several possible positions to determine the counterweight overhang 164. As shown in FIG. 5, for example, a position sensor 168a may be configured to measure a position of one of the lower arms 158. Alternatively or additionally, a position sensor 168b may be configured to measure a position of one of the upper arms 160. Still further, a position sensor 168c may alternatively or additionally be provided to measure a position or extension state of the counterweight hydraulic cylinder 162. While the position sensors 168a, 168b, 168c are depicted in FIG. 5 as proximity sensors, it will be appreciated that other types of sensors or switches may be used in any of the sensor locations.

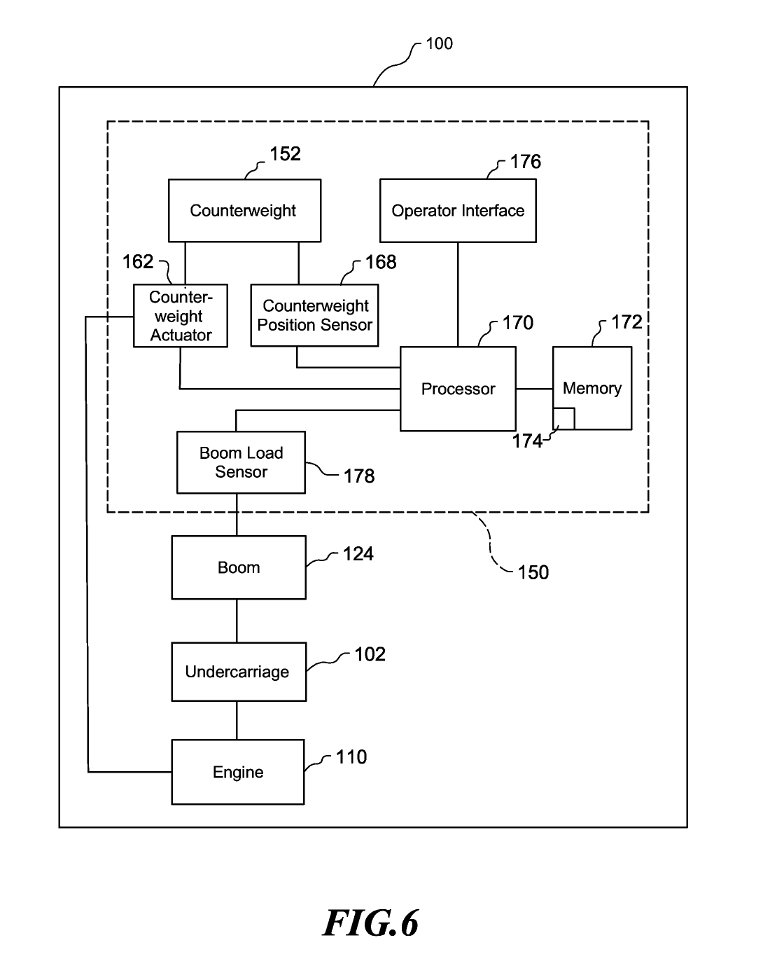

As schematically shown in FIG. 6, the counterweight system 150 may also include a processor 170 communicatively coupled to the counterweight position sensor 168. The processor 170 may be provided in any one of various forms. For example, the processor 170 provided as part of the electronic control unit (ECU) of the pipelayer 100, or it may be provided separate from the ECU as part of a dedicated counterweight system controller. A memory device 172, which may include electronically stored software 174, electronically communicates with the processor 170. An operator interface 176 may be provided on the control console 114, such as in the form of a control screen or the like that is configured to permit user input into the processor 170. The operator interface 176 may also include a display for providing information to the user, or a separate display may be provided independently of the operator interface 176.

The counterweight system 150 may be configured to provide feedback to the operator regarding the position of the counterweight. As used herein, the term “counterweight position information” is used to describe the type of feedback that may be provided to the operator based on a signal from the counterweight position sensor 168. As will be understood more fully below, the counterweight position information may be indicative of an actual counterweight position, a counterweight overhang distance, a current load capacity of the pipelayer, an indication that the counterweight should be moved (i.e., extended or retracted), or other information indicative of or derived from the counterweight position as determined by the counterweight position sensor.

For example, the display of the operator interface 176 may be operably coupled to the counterweight position sensor 168, either directly or through the processor 170 (as shown). The operator interface 176 may receive a counterweight position signal from the counterweight position sensor 168 that is indicative of counterweight position and display counterweight position information in the form of an actual counterweight position or actual counterweight overhang based on the counterweight position signal.

Because the counterweight 152 may have a known mass, in some embodiments, the counterweight position signal may be used to determine a counterweight moment, and the counterweight position information displayed by the operator interface 176 may include a current load capacity of the pipelayer 100 that corresponds to the counterweight moment associated with the current position of the counterweight 152 and the counterweight mass. That is, the processor 170 may determine the counterweight moment based on the known mass of the counterweight 152 and the counterweight overhang 164 indicated by the counterweight position sensor 168, and determine, based on overall pipelayer weight, boom length, and other factors known by those of skill in the art, the current maximum load that will maintain the pipelayer 100 in balance.

In some applications, the counterweight position information may be provided as an instruction or indication to the operator to prevent overstressing of the undercarriage 102 or other pipelayer structure. More specifically, the processor 170 may be used to identify when the counterweight position signal from the counterweight position sensor 168 is in the refracted position. In response, the processor 170 may communicate to the operator interface 176 or other display an instruction or indication that the counterweight 152 is in the retracted position, thereby to alert the operator to this condition. Additionally or alternatively, the processor 170 may automatically disable the counterweight hydraulic cylinder 162, or limit further movement of the counterweight hydraulic cylinder 162 in the retracted direction, in response to the counterweight position sensor 168 indicating that the counterweight 152 is in the retracted position. By preventing further operation of the counterweight hydraulic cylinder 162, the processor 170 will prevent over-retraction of the counterweight 152, which may otherwise cause the counterweight 152 to forcefully contact the pipelayer 100 as it retracts (known as “racking”). Additionally, by alerting the operator that the counterweight 152 is in the refracted position or otherwise disabling the counterweight hydraulic cylinder 162, the operator will be prevented from trying to further retract the counterweight 152, which may unduly stress the pipelayer structure.

Further, the counterweight system 150 may also provide feedback to the operator regarding the load acting on the boom 124. For example, the counterweight system 150 may include a boom sensor 178 configured to measure parameters indicative of the boom overhang 146 and boom load. In some applications, the boom sensor 178 may be provided as a load moment indicator (LMI) system, which includes a boom position sensor (for determining boom overhang 146) and a load cell (for determining boom load), and which calculates a boom moment based on the boom overhang 146 and boom load. The boom sensor 178 may further generate a boom load signal indicative of the boom moment. The boom load signal may be received by the operator interface 176, which in turn displays boom load information to the operator. In some embodiments, the boom load information may include an actual load value for the load currently carried by the pipelayer 100.

Further, the counterweight system 150 may provide the counterweight position information in the form of a current maximum load that is displayed to the operator. For example, the processor 170 may compare the boom moment indicated by the boom load signal to the counterweight moment indicated by the counterweight position signal and determine an instantaneous current maximum load for the current boom load. In some embodiments, the current load capacity (determined from the counterweight position signal) and the actual load value (determined from the boom load signal) may be expressed as a capacity usage value based on a ratio of the boom moment to the counterweight moment. Additionally or alternatively, the counterweight position information may include an indication or instruction displayed to the operator to move the counterweight 152, such as by extending or retracting the counterweight 152, based on the counterweight moment and boom moment.

Further, the counterweight system 150 may actively adjust the position of the counterweight 152 based on the counterweight and boom moment information. For example, the processor 170 may electronically communicate with the counterweight hydraulic cylinder 162, the boom sensor 178, and the counterweight position sensor 168. The processor 170 may receive the boom load and counterweight position signals and may be programmed to determine when the capacity usage value exceeds a capacity usage threshold. When the capacity usage exceeds the capacity usage threshold, the processor 170 may automatically command operation of the counterweight hydraulic cylinder 162 to move the counterweight 152 to a desired position between the retracted position and the deployed position, thereby to maintain in balance the pipelayer 100.

### INDUSTRIAL APPLICABILITY

From the foregoing, it can be seen that the technology disclosed herein has industrial applicability in a variety of settings such as, but not limited to, providing counterweight position information, such as a current load capacity, to the operator of a pipelayer. The counterweight position information may be provided along with boom load information to help the operator maintain in balance the pipelayer 100. Additionally or alternatively, the counterweight system 150 may use the counterweight position information to actively command the counterweight actuator to move the counterweight, thereby to balance the pipelayer 100.

While the foregoing has been made with primary reference to a pipelayer, it is to be understood that its teachings can be employed to provide counterweight position information to and/or actively maintain balance of any number of similar machines including, but not limited to, loaders, excavators, lift trucks, cherry pickers, back-hoes, fork-lifts, or any other movable vehicle where a load is being lifted at a distance from the main body of the vehicle and thereby creating a moment tending to tip the vehicle.

All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated. Moreover, all methods described herein can be performed in any suitable order unless otherwise indicated herein or otherwise clearly contradicted by context.

1. A pipelayer, comprising:
an undercarriage;
a boom movable relative to the undercarriage in a first lateral direction;
a counterweight movable relative to the undercarriage in a second lateral direction opposite the first lateral direction and ranging between a deployed position and a retracted position;
a counterweight position sensor configured to determine a current position of the counterweight and generate a counterweight position signal; and
an operator interface operably coupled to the counterweight position sensor and configured to display counterweight position information based on the counterweight position signal.

2. The pipelayer of claim 1, in which the counterweight position signal is indicative of a counterweight moment, and in which the counterweight position information displayed by the operator interface comprises a current load capacity of the pipelayer based on the counterweight moment.

3. The pipelayer of claim 1, further comprising a boom sensor configured to determine a boom load and generate a boom load signal, in which the operator interface is also coupled to the boom sensor and further configured to display boom load information based on the boom load signal.

4. The pipelayer of claim 3, further comprising a processor coupled to the boom sensor, the counterweight sensor, and the operator interface, the processor being programmed to determine the counterweight position information based on the counterweight position signal and communicate the counterweight position information to the operator interface.

5. The pipelayer of claim 4, in which:
the counterweight has a counterweight mass;
the boom load signal is indicative of a boom moment; and
the processor is further programmed to determine a counterweight moment based on the counterweight position signal and the counterweight mass.

6. The pipelayer of claim 5, in which:
the processor is further programmed to determine a current load capacity of the pipelayer based on the counterweight moment;
the counterweight position information displayed by the operator interface comprises the current load capacity of the pipelayer; and
the boom load information displayed by the operator interface comprises an actual load value.

7. The pipelayer of claim 6, in which the current load capacity and the actual load value are expressed as a capacity usage value based on a ratio of the boom moment to the counterweight moment.

8. The pipelayer of claim 7, further comprising a counterweight actuator operably coupled to the counterweight and the processor, wherein the processor is further programmed to automatically command operation of the counterweight actuator based on the capacity usage value.

9. The pipelayer of claim 5, in which:
the processor is further programmed to generate a counterweight move signal based on a comparison of the counterweight moment and the boom moment; and
the counterweight position information displayed by the operator interface comprises the counterweight move signal.

10. A method of operating a pipelayer, comprising:
detecting a position of a counterweight relative to an undercarriage using a counterweight position sensor and generating a counterweight position signal;
communicating the counterweight position signal to an operator interface; and
displaying, on the operator interface, counterweight position information based on the counterweight position signal.

11. The method of claim 10, in which in which the counterweight position signal is indicative of a counterweight moment, and in which the counterweight position information displayed by the operator interface comprises a current load capacity of the pipelayer based on the counterweight moment.

12. The method of claim 10, further comprising:
detecting a boom load using a boom sensor and generating a boom load signal;
communicating the boom load signal to the operator interface; and
displaying, on the operator interface, boom load information based on the boom load signal.

13. The method of claim 12, in which the counterweight has a counterweight mass, the method further comprising:
determining a counterweight moment based on the counterweight position signal and the counterweight mass; and
determining a boom moment based on the boom load signal;
wherein the counterweight position information displayed by the operator interface comprises a current load capacity of the pipelayer based on the counterweight moment; and
the boom load information displayed by the operator interface comprises an actual load value based on the boom moment.

14. The method of claim 13, in which the current load capacity and the actual load value are displayed as a capacity usage value based on a ratio of the boom moment to the counterweight moment.

15. The method of claim 14, further comprising:
providing a counterweight actuator operably coupled to the counterweight;
monitoring the capacity usage value; and
automatically commanding operation of the counterweight actuator based on the boom load.

16. A counterweight system for a pipelayer having an undercarriage, the counterweight system comprising:
a counterweight movable laterally relative to a first side of the undercarriage between a deployed position and a retracted position;
a counterweight position sensor configured to determine a current position of the counterweight and generate a counterweight position signal;
a processor coupled to the counterweight position sensor and configured to generate counterweight position information based on the counterweight position signal; and
an operator interface coupled to the processor and configured to display the counterweight position information.

17. The counterweight system of claim 16, in which the counterweight position signal is indicative of a counterweight moment, and in which the counterweight position information displayed by the operator interface comprises a current load capacity of the pipelayer based on the counterweight moment.

18. The counterweight system of claim 16, in which the pipelayer further comprises a boom movable laterally relative to a second side of the undercarriage, and in which the counterweight system further comprises a boom sensor configured to determine a boom load and generate a boom load signal, in which the processor is also coupled to the boom sensor and further configured to generate boom load information based on the boom load signal, and in which the operator interface is further configured to display the boom load information.

19. The counterweight system of claim 18, in which:
the counterweight has a counterweight mass;
the boom load signal is indicative of a boom moment; and
the processor is further programmed to:
determine a counterweight moment based on the counterweight position signal and the counterweight mass; and
determine a current load capacity of the pipelayer based on the counterweight moment;
wherein the counterweight position information displayed by the operator interface comprises the current load capacity of the pipelayer;
wherein the boom load information displayed by the operator interface comprises an actual load value;
wherein the current load capacity and the actual load value are expressed as a capacity usage value based on a ratio of the boom moment to the counterweight moment.

20. The counterweight system of claim 19, further comprising a counterweight actuator operably coupled to the counterweight and coupled to the processor, wherein the processor is configured to automatically move the counterweight between the retracted position and the deployed position based on the capacity usage value.
